(19) United States
(12) Patent Application Publication
(10) Pub. No.: US 2026/0189642 A1
(43) Pub. Date: Jul. 2, 2026

(54) HANDLING USER EQUIPMENT DURING UNAVAILABILITY PERIOD IN WIRELESS NETWORK

(71) Applicant: Samsung Electronics Co., Ltd., Suwon-si, Gyeonggi-do (KR)

(72) Inventors: Lalith KUMAR, Bengaluru (IN); Danish Ehsan HASHMI, Bengaluru (IN); Jagadeesh GANDIKOTA, Bengaluru (IN); Koustav ROY, Bengaluru (IN); Krishnamurthy D R, Bengaluru (IN)

(21) Appl. No.: 19/128,070

(22) PCT Filed: Nov. 6, 2023
(86) PCT No.: PCT/KR2023/017627

§ 371 Date: May 7, 2025

(30) Foreign Application Priority Data
Nov. 7, 2022 (IN) 202241063371
Oct. 1, 2023 (IN) 202341066008
Oct. 21, 2023 (IN) 202241063371

(51) Int. Cl. H04L 69/322; H04L 65/1069

(52) U.S. Cl. CPC H04L 69/322; H04L 65/1069

(57) ABSTRACT

The disclosure relates to a 5G or 6G communication system for supporting a higher data transmission rate. Embodiments herein disclose a method for handling an UE (100) during an unavailability period in a wireless network (1000) by the UE (100). The method includes detecting that a network apparatus (700) in the wireless network (1000) supports for the unavailability period in a last registration procedure. Further, the method includes determining an event is triggered, where the event makes the UE to become 2024/101810 unavailable. Further, the method includes creating a REGISTRATION REQUEST message by including an information to indicate unavailability period that starts immediately. Further, the method includes setting a follow-on request indicator to “No follow-on request pending” and not include an uplink data status IE or an allowed PDU session status IE in the REGISTRATION REQUEST message. Further, the method includes sending the REGISTRATION REQUEST message to the network apparatus (700).

### TECHNICAL FIELD

The embodiments herein relate to wireless communication, and more particularly relate to, a method and a User Equipment (UE) to handle the UE during an unavailability period in a wireless network.

### BACKGROUND ART

Fifth generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface /chitecture/ protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In general, to execute certain events, for example Operating System (OS) upgrade, silent reset at a modem or modem software updates (also commonly called as binary updates) there are 3 parties involved such as a device (e.g., UE or the like), an operator and an application function (AF). Once a User Equipment (UE) has downloaded a binary, the time when the UE performs the upgrade is left for the UE implementation, with possibly UE implementations seeking an user input. When the UE cannot execute the event (e.g. the storage capacity or the battery level are insufficient), they can delay execution of the event. These UE becomes unavailable (i.e. cannot interact with a fifth generation (5G) system) in the order of minutes whenever such operations are performed. The UEs become unavailable without prior knowledge from a core network and/or application function, this can impact critical operations of an application server when the operation depends on availability of the UE during the unavailability period (i.e. a period of time during which the UE is not available).

For the events, the UE becomes unavailable the “unavailability period” is determined by the UE for example events such as: Silent reset at Modem, Security patch updates, OS upgrade, Modem SW updates, Device reboot upon Modem setting changes via OMA-DM, Device reboot upon Modem setting changes via OMA-DM, Discontinuous coverage of the UEs for e.g. when the UE is in a satellite access, that is when UE is about to enter a discontinuous coverage.

FIG. 1 illustrates a sequence diagram indicating an unavailability period when a UE (100) is not available, according to prior art. At steps 1a-1c, the UE (100) is in a connected mode or an idle mode or an inactive state. At step 2, the UE (100) sends a non-access stratum (NAS) procedure with an unavailability period duration and additionally includes an uplink data status IE or an allowed PDU session status IE to the AMF entity (300). At step 3, the network apparatus (700) (as shown in FIG. 7) (e.g., AMF entity or the like) may start establishing a user plane resources for the UE (100) due to inclusion of the uplink data status IE/the active flag set or does not release a signalling connection due to follow-on request (FOR) bit. This creates a delay for the UE (100) to execute the event and execute the related procedure because signalling connection release to move the UE (100) to the IDLE mode is not executed but the network apparatus (700) has started to establish the user plane resources for the UE (100).

FIG. 2 illustrates a sequence diagram indicating the UE (100) triggering a NAS including unavailability period duration IE, according to prior art. At step 1, an AP layer of the UE (100) sends the unavailability period to a NAS/AS layer of the UE (100). At step 2, the NAS/AS layer of the UE (100) sends the initiated deregistration procedure (including unavailability period) to the 5GC NF (e.g., AMF entity) (300). At step 3, the unavailability period not delivered to the the 5GC NF. But, the UE (100) becomes unavailable. At step 4, due to the UE (100) becomes unavailable, the critical application service is impacted at the AF entity (400) because and application server is not aware about it.

Generally, when a power off procedure is executed, the UE (100) become un-available to indicate this to the network apparatus (700), the UE (100) triggers a deregistration procedure with an indication that the UE (100) is powering off. When the UE (100) fails to send the deregistration message due to lower layer failure, transmission failure or any other reasons as specified in 3GPP TS 24.501 then the UE (100) locally deregisters. That is, in general, the UE (100) waits for 5s to send, when it's successful, the operations are fine. Otherwise, the UE (100) anyways deregisters. This prior art procedure is OK because the UE (100) is powering OFF and there is no critical impact on the network side. When the UE (100) attempts to send unavailability period to the network apparatus (700), this unavailability period needs to be further forwarded to the Application server (also called as application function (AF) entity (400). Based on the unavailability period information, the application function (AF) entity (400) schedules second UE (not shown) to take up the role of the first UE (100) which is going un-available or perform some actions due to which application functions are not impacted. Thus, it's important for the UE (100) to make sure that deregistration/registration procedure is successfully executed so that unavailability period reaches the network apparatus (700) and further to the AF entity (400).

Thus, it is desired to address the above-mentioned disadvantages or other shortcomings or at least provide a useful alternative.

### DISCLOSURE OF INVENTION

### Technical Problem

The present disclosure relates to wireless communication systems and, more specifically, the invention relates to handling user equipment during unavailability period in wireless network.

### Solution to Problem

A principal object of the embodiments herein is to disclose a method and a UE for handling the UE during an unavailability period in a wireless network.

Another object of the embodiments herein is to create a registration request message by including an information element (IE) indicating an unavailability period upon determining that an event is triggered in the UE. The event makes the UE to become un-available.

Another object of the embodiments herein is to set a follow-on request indicator to “No follow-on request pending” and not include an uplink data status IE or an allowed PDU session status IE in the registration request message.

Another object of the embodiments herein is to send the registration request message to the network apparatus.

Another object of the embodiments herein is to start a timer T3540 to allow the network apparatus to release a N1 Non-access stratum (NAS) signalling connection when the UE has included the IE indicating unavailability period in the registration request message, locally release the established N1 NAS signalling connection when the timer T3540 is expired, and start the event after locally releasing the established N1 NAS signalling connection.

Accordingly, the embodiments herein disclose a method for handling an UE during an unavailability period in a wireless network. The method includes detecting, by the UE, that a network apparatus in the wireless network supports for the unavailability period in a last registration procedure. Further, the method includes determining, by the UE, an event is triggered, where the event makes the UE to become unavailable.

Further, the method includes creating, by the UE, a REGISTRATION REQUEST message by including an information to indicate unavailability period that starts im-mediately. Further, the method includes setting, by the UE, a follow-on request indicator to “No follow-on request pending” and not include an uplink data status IE or an allowed PDU session status IE in the REGISTRATION REQUEST message.

Further, the method includes sending, by the UE, the REGISTRATION REQUEST message to the network apparatus.

In an embodiment, the UE indicates the unavailability period that starts immediately by including an unavailability period duration or an unavailability period duration IE in a Non-Access Stratum (NAS) message and not including a start time in the REGISTRATION REQUEST message.

In another embodiment, the UE indicates the unavailability period that starts im-mediately by including an unavailability period duration or unavailability period duration IE in NAS message and by including start time indicating a value that unavailability period starts immediately in the REGISTRATION REQUEST message with value indicating start of unavailability period immediately.

In an embodiment, sending, by the UE, the REGISTRATION REQUEST message to the network apparatus includes determining, by the UE, whether the UE is able to store Mobility management (MM) context and session management (SM) context of the wireless network, and sending, by the UE, the registration request message to the network apparatus when the UE is able to store the MM context and the SM context and the event is triggered in the UE that makes the UE unavailable in the wireless network.

In an embodiment, further, the method includes starting, by the UE, a timer T3540 to allow the network apparatus to release N1 NAS signalling connection when the UE has included the information element indicating unavailability period in the REGISTRATION REQUEST message. Further, the method includes detecting, by the UE, whether the timer T3540 is expired. Further, the method includes locally releasing, by the UE, the established N1 NAS signalling connection when the timer T3540 is expired. Further, the method includes staring, by the UE, an event after locally releasing the established N1 NAS signalling connection.

In an embodiment, the event is one of a silent reset at a modem of the UE, a security patch update at the UE, an operating system (OS) upgrade at the UE, a modem software update at the UE, a device reboot upon Modem setting changes via Open Mobile Alliance Device Management (OMA-DM), and a discontinuous coverage period of the UE applicable for satellite access. e.g. when the UE is in a satellite access, that is when UE is about to enter a discontinuous coverage

In an embodiment, the UE does not include an uplink data status IE or an allowed PDU session status IE in the REGISTRATION REQUEST message.

In an embodiment, the UE does not include the uplink data status IE or the allowed PDU session status IE in the REGISTRATION REQUEST message even when the UE has one or more active always-on PDU sessions associated with a 3GPP access.

Accordingly, the embodiments herein disclose a UE for handling unavailability period in a wireless network. The UE includes an unavailability period collision controller communicatively coupled to a memory and a processor. The unavailability period collision controller is configured to detect that a network apparatus in the wireless network supports for the unavailability period in a last registration procedure. Further, the unavailability period collision controller is configured to determine that an event is triggered. The event makes the UE to become unavailable. Further, the unavailability period collision controller is configured to create a REGISTRATION REQUEST message by including an information to indicate unavailability period that starts immediately. Further, the unavailability period collision controller is configured to set a follow-on request indicator to “No follow-on request pending” and not include an uplink data status IE or an allowed PDU session status IE in the REGISTRATION REQUEST message. Further, the unavailability period collision controller is configured to send the REGISTRATION REQUEST message to the network apparatus.

These and other aspects of the embodiments herein will be better appreciated and understood when considered in conjunction with the following description and the accompanying drawings. It should be understood, that the following descriptions, while indicating preferred embodiments and numerous specific details thereof, are given by way of illustration and not of limitation. Many changes and modifications may be made within the scope of the embodiments herein.

### Advantageous Effects of Invention

Advantages, and salient features of the invention will become apparent to those skilled in the art from the following detailed description, which, taken in conjunction with the annexed drawings, discloses exemplary embodiments of the invention.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a sequence diagram indicating an unavailability period when a UE is not available, according to prior art;

FIG. 2 illustrates a sequence diagram indicating the UE triggering a NAS including unavailability period duration IE, according to prior art;

FIG. 3 illustrates a sequence diagram of the UE handling an unavailability period in a wireless network, according to the embodiments as disclosed herein;

FIG. 4 illustrates a sequence diagram illustrating the UE triggering events to become unavailable while a AP layer of the UE receives an indication of an unavailability successfully delivered information from a NAS/AS layer of the UE, according to the embodiments as disclosed herein;

FIG. 5 illustrates a sequence diagram of different conditions of the UE unavailability period, according to the embodiments as disclosed herein;

FIG. 6 illustrates another sequence diagram of different conditions of the UE unavailability period based on a timer, according to the embodiments as disclosed herein;

FIG. 7 shows various hardware components of the UE, according to the embodiments as disclosed herein; and

FIG. 8 is a flow chart illustrating a method for handling the UE during an unavailability period in the wireless network, according to the embodiments as disclosed herein.

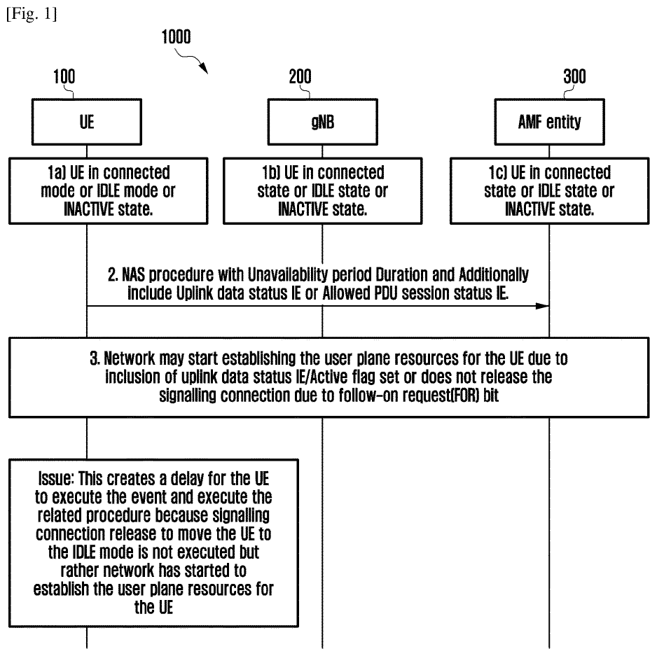

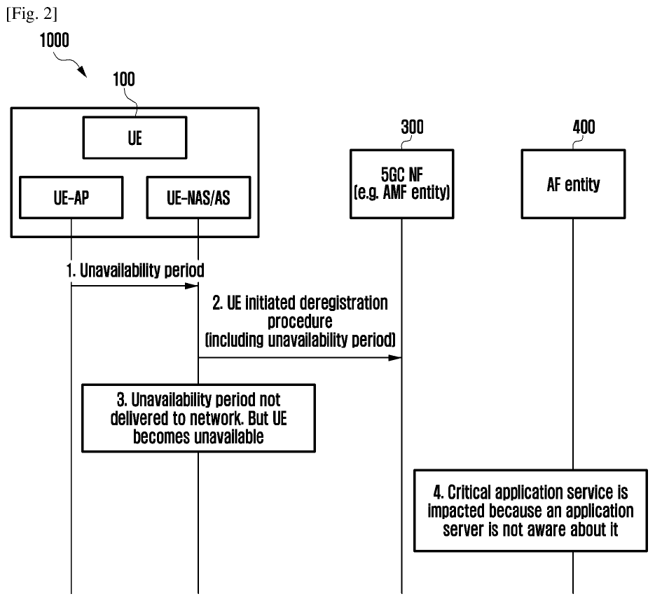

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein disclose a method for handling an UE during an unavailability period in a wireless network. The method includes detecting, by the UE, that a network apparatus in the wireless network supports for the unavailability period in a last registration procedure. The support for the unavailability period is negotiated between the UE and the network for e.g., UE indicates support of this features in NAS message to the network and in response the network indicates to the UE the support of this feature back to the UE in the NAS message like registration accept. The support indication name can be unavailability period supported, discontinuous coverage supported or extended discontinuous coverage supported etc. Further, the method includes determining, by the UE, an event is triggered, where the event makes the UE to become unavailable. Further, the method includes creating, by the UE, a REGISTRATION REQUEST message by including an information to indicate unavailability period that starts immediately. Further, the method includes setting, by the UE, a follow-on request indicator to “No follow-on request pending” and not include an uplink data status IE or an allowed PDU session status IE in the REGISTRATION REQUEST message. Further, the method includes sending, by the UE, the REGISTRATION REQUEST message to the network apparatus.

In an embodiment, when the UE triggers a NAS message including unavailability period duration Information Element (IE), the UE does not include Uplink Data Status IE, Allowed PDU session status IE, Active Status IE or Follow on Request bit. Henc, that the procedure can be executed quickly and the UE can be released to the IDLE state or Inactive state as quickly as possible.

In an embodiment, when the UE includes unavailability period duration IE and also one or more of the: Uplink Data Status IE, Allowed PDU session status IE, Active Status IE or Follow on Request bit, the Access and Mobility Management Function (AMF) entity or Mobility Management Entity (MME) entity neglects/ignores/discards the Uplink Data Status IE, Allowed PDU session status IE, Active Status IE or Follow on Request bit received from the UE. The network apparatus progresses with unavailability period duration and release the UE to IDLE or Inactive state.

In an embodiment, when the UE includes the unavailability period duration IE and also one or more of the: Uplink Data Status IE, Allowed PDU session status IE, Active Status IE or Follow on Request bit, the AMF entity or the MME entity, neglects/ignores/discards the Unavailability period duration received from the UE. The UE and the network apparatus progress with the Uplink data status IE, the allowed PDU session status IE, the Active Status IE or the Follow-on Request bit status handling to establish the user plane resources or do not release the NAS signaling connection.

In an embodiment, the UE determines that delivery/sending/indication of unavailability period is not successful. Whenever, the UE determines that /livery/ sending/indication of the unavailability period is not successful then, the UE can remain in registered state. For example, the UE sends the deregistration message to send the unavailability period but in response to the NAS message, the UE determines that the delivery/sending/indication of the unavailability period is not successful then the UE can enter again the 5GMM_REGISTERED state. Hence, the UE can attempt to send unavailability period again after some time and differ the execution of the events which can trigger the UE to become unavailable.

In an embodiment, the term unavailability period is included in the NAS message. In an example, the registration request message, a TAU message, and an attach message is used, which implies that unavailability period is present in the respective NAS message.

In an embodiment, the term unavailability period is not included in the NAS message. In an example, the registration request, the TAU message and the attach message is used, which implies that unavailability period is not present in the respective NAS message.

In an embodiment, the term start time is included in the NAS message. In an example the registration request message, the TAU message and the attach message is used, which implies that start time is present in the respective NAS message.

In an embodiment, the term start time is not included in the NAS message. In an example the registration request message, the TAU message and the attach message is used, which implies that start time is NOT present in the respective NAS message.

The term “included” implies “present” in the respective message. The term “not included” implies “not present” in the respective message.

The network apparatus is illustrated using a 5GC as an example i.e., for e.g., AMF, but the same invention is applicable to an Evolved Packet System (EPS) i.e., for MME. Similarly, respective NAS message should be applied for e.g. registration request/registration accept for the 5GS and Attach/TAU request for EPS and Attach/TAU accept for the EPS. In other words, the network apparatus used in the patent discourse, the embodiment is explained using any 5G Core Network Function for e.g. AMF. The network apparatus could be any 5G/EUTRAN Core Network Entities like AMF/SMF/MME/UPF or the network apparatus could be any 5G/EUTRAN RAN Entity like eNodeB (eNB) or gNodeB (gNB) or NG-RAN etc.

The terms uanavailability duration IE or unavailability information are used inter-changeably and have the same meaning.

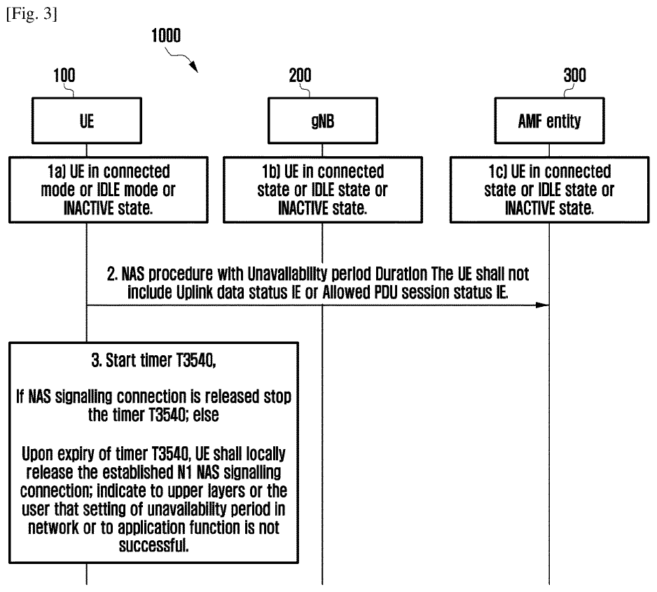

Referring now to the drawings, and more particularly to FIGS. 3 through 8, where similar reference characters denote corresponding features consistently throughout the figures, there are shown example embodiments.

FIG. 3 illustrates a sequence diagram of a UE (100) handling an unavailability period in a wireless network (1000), according to the embodiments as disclosed herein. At step la-Step 1c, the UE (100) is in the connected mode or the idle mode or the inactive state. At step 2, the UE (100) sends the NAS message like registration request message with the unavailability period duration. The UE (100) does not include the uplink data status IE or the allowed PDU session status IE. At step 3, the UE (100) starts the timer T3540. When the NAS signalling connection is released, the UE (100) stops the timer T3540. Upon expiry of timer T3540, the UE (100) locally releases the established N1 NAS signalling connection. Further, the UE (100) indicates to the upper layers or the user that setting of unavailability period in the network apparatus (700) or to application function is not successful.

When the UE (100) triggers a NAS procedure (e.g., registration request message or deregistration request message) including unavailability period duration IE (also called as unavailability period, unavailability period IE etc.) and does not include start time (also called as start of unavailability period), the UE (100) does not include Uplink Data Status IE, Allowed PDU session status IE, Active Status IE or Follow on Request bit. Hence, the procedure can be executed quickly and the UE (100) can be released to the IDLE state or the inactive state as quickly as possible

In an embodiment, when the UE (100) includes the unavailability period duration IE and also one or more of the: Uplink Data Status IE, Allowed PDU session status IE, Active Status IE or Follow on Request bit, the AMF entity (300) or MME entity neglects/ignores/discards the Uplink Data Status IE, Allowed PDU session status IE, Active Status IE or Follow on Request bit received from the UE (100). The network apparatus (700) progresses with unavailability period duration and release the UE (100) to the IDLE state or the inactive state.

In one embodiment, the UE (100) includes the unavailability period duration IE and optionally start time (start time indicates start of unavailability period), in general, the UE (100) indicates that unavailability period starts immediately and also one or more of the: Uplink Data Status IE, Allowed PDU session status IE, Active Status IE or Follow on Request bit to the AMF entity (300) or the MME, the AMF entity (300) or the MME neglects/ignores/discards the Uplink Data Status IE, Allowed PDU session status IE, Active Status IE or Follow on Request bit received from the UE (100). The network apparatus (700) progresses with unavailability period duration and start time (start time indicates start of unavailability period) and release the UE (100) to IDLE or Inactive state.

In yet another embodiment, when the UE (100) includes Unavailability period duration IE and also one or more of the: Uplink Data Status IE, Allowed PDU session status IE, Active Status IE or Follow on Request bit the AMF entity (300) or the MME entity, neglects/ignores/discards the Unavailability period duration received from the UE (100). The UE (100) and network apparatus (700) progresses with Uplink Data Status IE, Allowed PDU session status IE, Active Status IE or Follow on Request bit status handling to establish the user plane resources or do not release the NAS signaling connection.

In an embodiment, when the UE (100) and network apparatus (700) support the unavailability period and an event is triggered in the UE (100) that would make the UE (100) unavailable for a certain period of time, the UE (100) may store the MM and SM context in the USIM or Non-Volatile memory to be able to reuse the MM and SM context after the unavailability period. Further, the UE (100) includes unavailability period duration in the NAS message (like registration request message or deregistration request message etc. The UE (100) sets the Follow-on request indicator to “No follow-on request pending”. In addition, the UE (100) does not include the Uplink data status IE or the Allowed PDU session status IE in the NAS message like REGISTRATION REQUEST message even when the UE (100) has one or more active always-on PDU sessions associated with the 3GPP access. Additionally, the UE (100) starts the timer T3540.

In an embodiment, when the UE (100) and the network apparatus (700) support the unavailability period and the event is triggered in the UE that would make the UE un-available for a certain period of time, the UE (100) may store the MM and SM context in USIM or Non-Volatile memory to be able to reuse the MM and SM context after the unavailability period. Further, the UE (100) includes unavailability period duration and does not include start time (indicates start of unavailability period) in the NAS message (like registration request message or deregistration request message etc. In general the UE (100) indicates in the NAS message that unavailability period starts im-mediately, then the UE (100) sets the Follow-on request indicator to “No follow-on request pending”. In addition, the UE (100) does not include the Uplink data status IE or the Allowed PDU session status IE in the NAS message like REGISTRATION REQUEST message even when the UE (100) has one or more active always-on PDU sessions associated with the 3GPP access. Additionally, the UE (100) starts the timer T3540.

To allow the network apparatus (700) to release the N1 NAS signalling connection, the UE (100) starts timer T3540. When the NAS signaling connection is released before the expiry of the timer T3540, stop the respective timer T3540; else Upon expiry of timer T3540, the UE (100) locally releases the established N1 NAS signalling connection; indicate to upper layers or the user that setting of unavailability period in the network apparatus (700) or to application function is not successful.

When the network apparatus (700) receives the unavailability period duration IE over 3GPPA, the network apparatus (700) triggers release of the N1 NAS signalling connection over both 3GPP access and non-3GPP access. When the network apparatus (700) receives the unavailability period duration IE over non-3GPPA, the network apparatus (700) triggers release of the N1 NAS signalling connection over both 3GPP access and non-3GPP access.

In 5GMM-CONNECTED mode with RRC inactive indication, when the UE (100) requests the lower layers to transition to RRC_CONNECTED state at initiation of a registration procedure, a service request procedure or a de-registration procedure, upon fallback indication from lower layers, the UE (100) enters the 5GMM-IDLE mode and proceeds with the pending procedure. When the pending procedure is a service request or registration request procedure and the SERVICE REQUEST message, the CONTROL PLANE SERVICE REQUEST message or the REGISTRATION REQUEST message does not include UE (100) request type IE with Request type value set to “NAS signalling connection release” or the REGISTRATION REQUEST message does not include unavailability period duration IE (optionally without start time of unavailability period), in general the UE (100) indicates in the NAS message that unavailability period does not start immediately, the UE (100) includes the Uplink data status IE in the SERVICE REQUEST message, the CONTROL PLANE SERVICE REQUEST message or in the REGISTRATION REQUEST message, indicating the PDU session(s) without active user-plane resources for which the UE (100) has pending user data to be sent, if any, and the PDU session(s) for which user-plane resources were active prior to receiving the fallback indication, if any.

In 5GMM-CONNECTED mode with RRC inactive indication, when the UE (100) requests the lower layers to transition to RRC_CONNECTED state at initiation of a registration procedure, a service request procedure or a de-registration procedure, upon fallback indication from lower layers, the UE (100), then enters the 5GMM-IDLE mode and proceeds with the pending procedure. When the pending procedure is a registration request procedure and the REGISTRATION REQUEST message includes unavailability period duration IE (and Optionally without the start time of unavailability period), in general the UE (100) indicates in NAS message that unavailability period starts immediately, the UE (100) does not include the Uplink data status IE in the SERVICE REQUEST message, the CONTROL PLANE SERVICE REQUEST message or in the REGISTRATION REQUEST message, indicating the PDU session(s) without active user-plane resources for which the UE (100) has pending user data to be sent, if any, and the PDU session(s) for which user-plane resources were active prior to receiving the fallback indication, if any.

In an embodiment, When the UE (100) in 5GMM-CONNECTED mode over 3GPP access receives a fallback indication from lower layers, and the UE (100) has a pending registration procedure, a service request procedure, or a de-registration procedure, the UE (100): a) enter 5GMM-IDLE mode, b) proceeds with the pending procedure. When the pending procedure is a registration procedure and the SERVICE REQUEST message, the CONTROL PLANE SERVICE REQUEST message or the REGISTRATION REQUEST message does not include UE (100) request type IE with Request type value set to “NAS signaling connection release”, or the REGISTRATION REQUEST message does not include unavailability period duration IE and optionally includes unavailability period duration IE with start time of unavailability period and the start time value indicates that unavailability period is started at later point of time and is not immediate for e.g. the UE (100) indicates 200 seconds later, i.e. in general UE in NAS message indicates that unavailability period is not stared immediately, the UE (100) includes the Uplink data status IE in the SERVICE REQUEST message, or in the REGISTRATION REQUEST message, indicating the PDU session(s) for which user-plane resources were not active prior to receiving a fallback indication from the lower layers and the UE (100) has pending user data to be sent over 3GPP access, if any, and the PDU session(s) for which user-plane resources were active prior to receiving the fallback indication.

In an embodiment, When the UE in 5GMM-CONNECTED mode over 3GPP access receives a fallback indication from lower layers, and the UE has a pending registration procedure, a service request procedure, or a de-registration procedure, the UE: a) enters 5GMM-IDLE mode, b) proceed with the pending procedure. When the pending procedure is a registration procedure and the SERVICE REQUEST message, the CONTROL PLANE SERVICE REQUEST message or the REGISTRATION REQUEST message does not include UE request type IE with Request type value set to “NAS signalling connection release”, or the REGISTRATION REQUEST message include unavailability period duration IE and Optionally without start time of unavailability period i.e. in general NAS message indicates that unavailability period is started immediately, the UE (100) does not include the Uplink data status IE in the SERVICE REQUEST message, or in the REGISTRATION REQUEST message, indicating the PDU session(s) for which user-plane resources were not active prior to receiving a fallback indication from the lower layers and the UE (100) has pending user data to be sent over 3GPP access, if any, and the PDU session(s) for which user-plane resources were active prior to receiving the fallback indication.

In an embodiment, without including the start time implies start time is not included in the NAS message like registration request message, deregistration request message or start time is included in the NAS message but indicates a value that unavailability period is not starting immediately but at later point of time.

In summary, for all scenarios discussed in this embodiment, the UE (100) sets the Follow-on request indicator to “No follow-on request pending”. In addition, the UE (100) does not include the Uplink data status IE or the Allowed PDU session status IE in the NAS message like REGISTRATION REQUEST message when the UE (100) includes the information in the NAS message that unavailability period is started im-mediately.

The UE (100) indicates unavailability period is started immediately by at least one of the below methods:
1. By including unavailability period information and indicate unavailability type reason is due to discontinuous coverage and does not include unavailability duration and/or start time.
2. by including unavailability period duration; or
3. by including unavailability period duration in NAS message and not including the start time (start time of unavailability period) in the NAS message; or
4. by including the unavailability period duration or the unavailability period duration IE in the NAS message and by including the start time indicating a value that unavailability period starts immediately in the NAS message for e.g., zero seconds or any value which can be defined in the protocol that indicates unavailability period starts immediately etc.

In summary, for all the scenario discussed in the embodiment, the UE (100) sets the Follow-on request indicator to “follow-on request pending”. In addition, the UE (100) may include the Uplink data status IE or the Allowed PDU session status IE in the NAS message like REGISTRATION REQUEST message when the UE (100) includes the information in the NAS message that unavailability period is not be started im-mediately.

The UE (100) indicates unavailability period is not be started immediately by at least one of the below methods:
1. by NOT including unavailability period duration or NOT including unavailability period duration IE or unavailability period information IE in NAS message.
2. The UE (100) includes unavailability period duration and also by including the start time (start time of unavailability period) in the NAS message or by including start time by indicating a value that unavailability period starts at later time (for e.g., after 200 seconds or the like) in the NAS message.
3. The UE (100) does not include unavailability period duration but by including the start time (start time of unavailability period) in the NAS message by indicating a value that unavailability period starts at later time (for e.g., after 200 seconds or the like) in the NAS message.
4. The UE (100) does not include unavailability period duration (e.g., unavailability period duration IE) and also does not include start time (start time of unavailability duration).
5. The UE does not include the unavailabity type i.e., the reason for unavailability type.

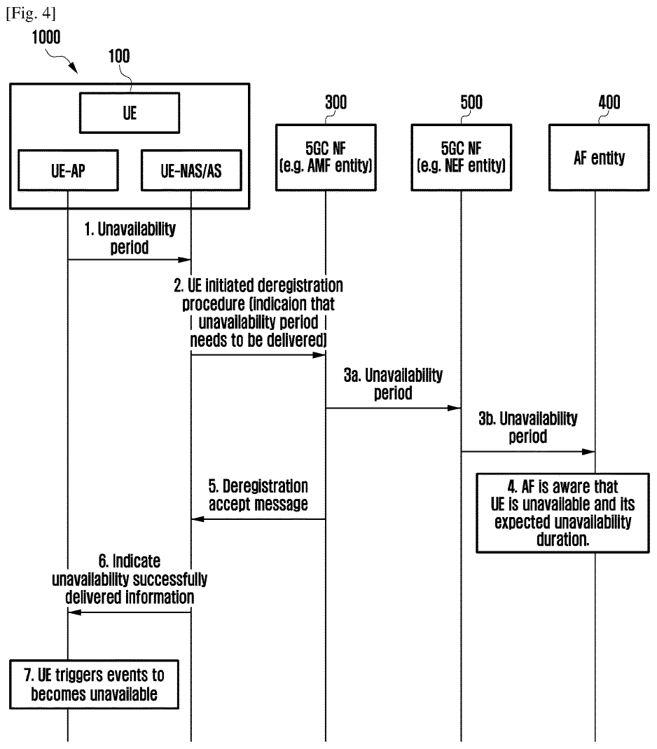

FIG. 4 illustrates a sequence diagram illustrating the UE (100) triggering events to become unavailable while the AP layer of the UE (100) receives an indication of an unavailability successfully delivered information from a NAS/AS layer of the UE (100), according to the embodiments as disclosed herein.

When UE (100) indicates the unavailability period in the Deregistration request message or registration request message or any other NAS message, the UE (100) does include with one or any combination of below information elements:
The de-registration type “normal de-registration”,
The de-registration type “switch off” and also include the “unavailability period”,
Any new indication in the DEREGISTRATION REQUEST message or REGISTRATION REQUEST message or any other NAS message, and
Include the “unavailability period”.

This indication helps the AMF entity (300) to understand this message is sent to deliver “unavailability period” to the AF entity (400).

The UE (100) starts the timer T3521 waiting for acknowledgement from the network apparatus (700) i.e., the DEREGISTRATION ACCEPT message or any other NAS message when DEREGISTRATION REQUEST message is sent. Otherwise UE (100) starts T3511 timer when REGISTRATION REQUEST message is sent.

In an embodiment, when the AMF entity (300) receives DEREGISTRATION REQUEST message with one or any combination of below information elements:
The de-registration type “normal de-registration”; or
The de-registration type “switch off” and also include the “unavailability period”; or
“unavailability period”.

The AMF entity (300) sends the deregistration accept message. In general, when the AMF entity (300) receives or determines that the AMF entity (300) has received unavailability period in any NAS message like registration request or deregistration request message, the AMF entity (300) sends the response NAS message like registration accept or the deregistration accept message to the UE (100).

In another embodiment, the AMF entity (300) sends an indication to the UE (100) in response to the NAS message to indicate successful reception of the unavailability period. In yet embodiment, the AMF entity (300) sends the indication to the UE (100) in response NAS message like registration accept or the deregistration accept to indicate successful reception of the unavailability period and successful deliver of unavailability period to the AF entity (400) via a NEF entity (500).

When the UE (100) receives the 1) response NAS message like registration accept or the deregistration accept message, or 2) indication to the UE (100) in response to the NAS message to indicate successful reception of the unavailability period, or 3) indication to the UE (100) in response to the NAS message like registration accept or the deregistration accept to indicate successful reception of the unavailability period and/or successful deliver of unavailability period to the AF entity (400) via the NEF entity (500), then the NAS layer of the UE (100) indicates that unavailability period updating to network apparatus (700) and application function is successful to the upper layers.

In an embodiment, when the AMF entity (300) received unavailability period in the NAS message and “Loss of Connectivity” event subscription for the UE (100) is determined then, the AMF entity (300) includes unavailability period in the event notification report even though the UE (100) is not deregistered.

In yet another embodiment, when the UE (100) sets de-registration type to switch off and does not include unavailability period then the UE (100) does not send the de-registration accept message to the UE (100).

As shown in FIG. 4, at step 1, the AP layer of the UE (100) sends the unavailability period to the NAS/AS layer of the UE (100). At step 2, the NAS/AS layer of the UE (100) sends the UE initiated deregistration procedure to the 5GC NF (e.g., AMF entity (300) or the like). The UE initiated deregistration procedure indicates that unavailability period needs to be delivered to the 5GC NF (e.g., AMF entity (300) or the like). At step 3a, the 5GC NF sends the unavailability period to the NEF entity (500). At step 3b, the NEF entity (500) sends the unavailability period to the AF entity (400). At step 4, the AF entity (400) is aware that UE (100) is unavailable and the expected unavailability duration. At step 5, the AMF entity (300) sends the deregistration accept message to the NAS/AS layer of the UE (100). At step 6, the NAS/AS layer of the UE (100) indicates unavailability successfully delivered information to the AP layer of the UE (100). At step 7, the UE (100) triggers events to become unavailable.

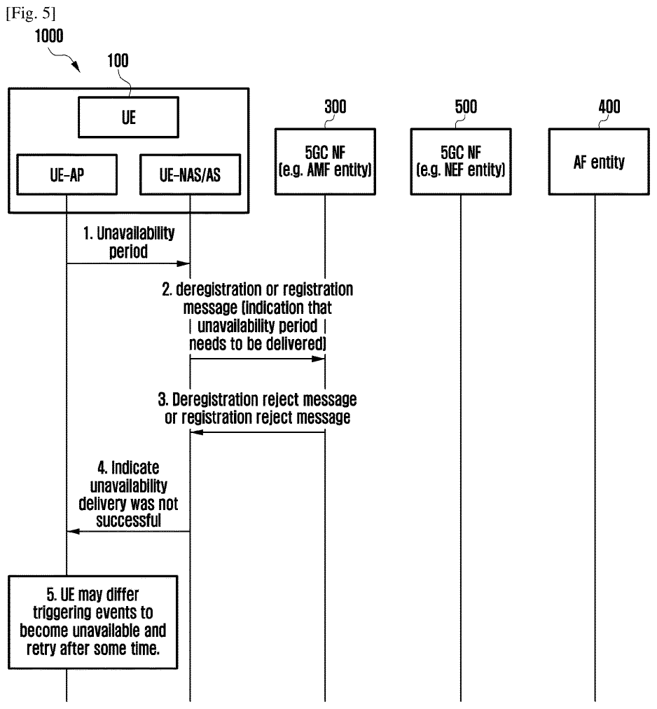

FIG. 5 illustrates a sequence diagram of different conditions of the UE (100) unavailability period, according to the embodiments as disclosed herein. When the UE (100) does not receive the deregistration accept message, on first four expiries of the timer, the UE (100) retransmits the DEREGISTRATION REQUEST message and resets and restarts timer T3521. On the fifth expiry of timer T3521, the de-registration procedure is aborted and NAS layer of the UE (100) indicates that unavailability period updating to network apparatus (700) and application function is not successful to the upper layers.

When the UE (100) receives the deregistration reject message, registration reject message or the UE (100) determines that the UE (100) cannot send the deregistration request message or the registration request message to the network apparatus (700) for e.g. due to:
1. Lower layer failure or release of the N1 NAS signalling connection before reception of RESPONSE NAS message like DEREGISTRATION ACCEPT message or REGISTRATION ACCEPT message.
2. The lower layers indicate that the access attempt is barred.
3. Transmission failure of DEREGISTRATION REQUEST or REGISTRATION REQUEST message.

then the NAS layer of the UE (100) indicates that unavailability period updating to the network apparatus (700) and the application function is not successful to the upper layers. In yet another embodiment, the UE (100) indicates to upper layers after multiple retries and attempt counter reaches certain threshold like 4 or 5 or 6. The UE (100) differs the triggering events to become unavailable and retry after some time.

When the UE (100) receives the response NAS message like deregistration accept message or registration accept the NAS layer of the UE (100) indicates that unavailability period updating (informing or indicating) to network apparatus (700) and application function is successful to the upper layers.

The upper layers in this embodiment are the application layer in the UE (100) i.e., indication is to one or more the applications in the UE (100).

In an embodiment, the methods for the UE (100) to determine that /livery/ sending/indication of unavailability period is not successful are discussed. Whenever the UE (100) determines that delivery/sending/indication of unavailability period is not successful then UE (100) can remain in registered state. In an example, when the UE (100) sends the deregistration message to send the unavailability period but in response NAS message, the UE (100) determines that delivery/sending/indication of unavailability period is not successful then the UE (100) can enter again 5GMM_REGISTERED state. Hence, UE (100) can attempt to send unavailability period again after some time and differ the execution of the events which can trigger the UE (100) to become unavailable.

As shown in the FIG. 5, at step 1, the AP layer of the UE (100) sends the unavailability period to the NAS/AS layer of the UE (100). At step 2, the NAS/AS layer of the UE (100) sends the UE initiated deregistration procedure to the 5GC NF (e.g., AMF entity (300) or the like). The UE initiated deregistration procedure indicates that unavailability period needs to be delivered to the 5GC NF (e.g., AMF entity (300) or the like). At step 3, the 5GC NF (e.g., AMF entity (300)) sends the deregistration reject message or registration reject message to the NAS/AS layer of the UE (100). At step 4, the NAS/AS layer of the UE (100) indicates that the unavailability delivery is not successful to the AP layer of the UE (100). At step 5, the UE (100) may differ triggering events to become unavailable and retry after some time.

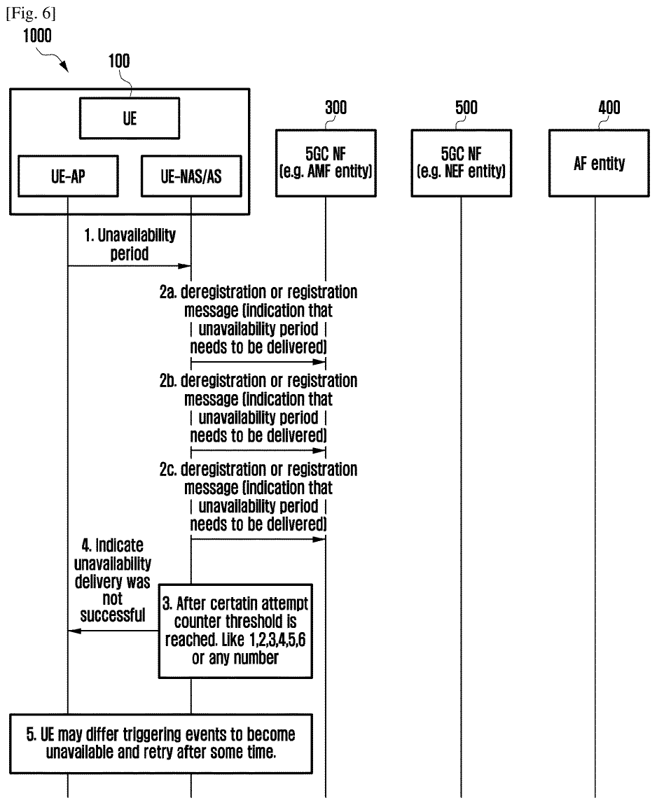

FIG. 6 illustrates another sequence diagram of different conditions of the UE unavailability period based on a timer, according to the embodiments as disclosed herein. As shown in FIG. 6, at step 1, the AP layer of the UE (100) sends the unavailability period to the NAS/AS layer of the UE (100). At step 2a-At step 2c, the NAS/AS layer of the UE (100) sends the deregistration or registration message to the 5GC NF (e.g., AMF entity (300) or the like). The deregistration or registration message indicates that unavailability period needs to be delivered to the 5GC NF (e.g., AMF entity (300) or the like). At step 3, the NAS/AS layer of the UE (100) determines that the attempt counter threshold is reached. At step 4, the NAS/AS layer of the UE (100) indicates that unavailability delivery is not successful to the AP layer of the UE (100). At step 5, the UE (100) may differ triggering events to become unavailable and retry after some time.

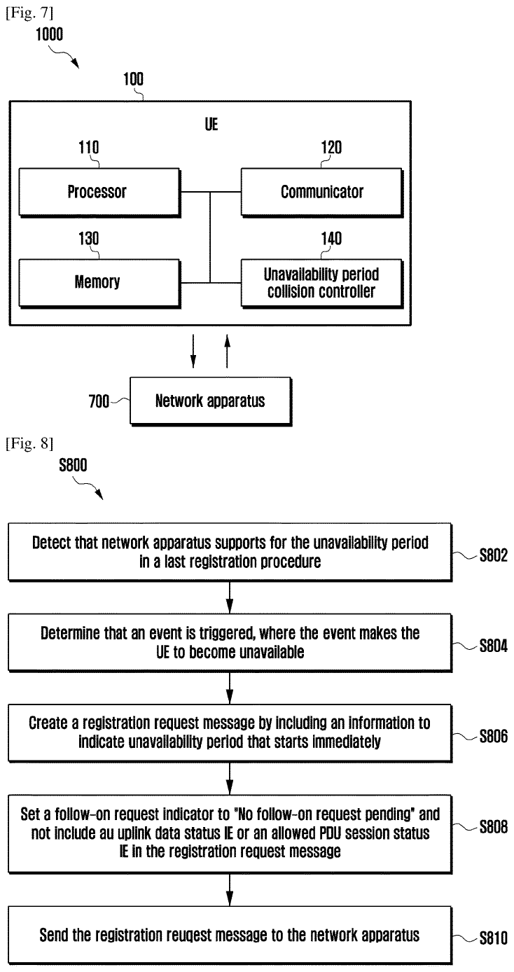

FIG. 7 shows various hardware components of the UE (100) for handling unavailability period in the wireless network (1000), according to the embodiments as disclosed herein. In an embodiment, the wireless network (1000) includes the UE (100) and the network apparatus (700). The UE (100) can be, for example, but not limited to a laptop, a smart phone, a desktop computer, a notebook, a Device-to-Device (D2D) device, a vehicle to everything (V2X) device, a foldable phone, a smart TV, a tablet, an immersive device, and an internet of things (IoT) device. The network apparatus (700) can be an AMF entity (300). In an embodiment, the UE (100) includes a processor (110), a communicator (120), a memory (130) and an unavailability period collision controller (140). The processor (110) is coupled with the communicator (120), the memory (130) and the unavailability period collision controller (140).

The unavailability period collision controller (140) detects that the network apparatus (700) supports for the unavailability period in the last registration procedure. Further, the unavailability period collision controller (140) determines that an event is triggered. The event makes the UE (100) to become unavailable. The event is one of a silent reset at the modem of the UE (100), the security patch update at the UE (100), the OS upgrade at the UE (100), the modem software update at the UE (100), the device reboot upon Modem setting changes via the OMA-DM, and the discontinuous coverage period of the UE (100) applicable for satellite access.

Based on the event, the unavailability period collision controller (140) creates a REGISTRATION REQUEST message/TRACKING AREA UPDATE (TAU) message/ATTACH message which indicates registration in 5GS or EPS system by including an information to indicate unavailability period that starts immediately. In an embodiment, the UE (100) indicates the unavailability period that starts immediately by including the unavailability period duration or the unavailability period duration IE in the NAS message and not including a start time in the REGISTRATION REQUEST/TAU message. In another embodiment, the UE (100) indicates the unavailability period that starts immediately by including an unavailability period duration or unavailability period duration IE in NAS message and by including start time indicating a value that unavailability period starts immediately in the REGISTRATION REQUEST message with value indicating start of unavailability period immediately. Further, the unavailability period collision controller (140) sets the follow-on request indicator to “No follow-on request pending” in the REGISTRATION REQUEST message.

Further, the unavailability period collision controller (140) sends the REGISTRATION REQUEST message to the network apparatus (700). In an embodiment, the unavailability period collision controller (140) determines whether the UE (100) is able to store the MM context and SM context of the wireless network (1000). Further, the unavailability period collision controller (140) sends the registration request message to the network apparatus (700) when the UE (100) is able to store the MM context and the SM context and the event is triggered in the UE (100) that makes the UE (100) unavailable in the wireless network (1000).

Further, the unavailability period collision controller (140) starts the timer T3540 to allow the network apparatus (700) to release N1 NAS signalling connection when the UE (100) has included the information element indicating unavailability period in the REGISTRATION REQUEST message. Further, the unavailability period collision controller (140) detects whether the timer T3540 is expired. Further, the unavailability period collision controller (140) locally releases the established N1 NAS signalling connection when the timer T3540 is expired. Further, the unavailability period collision controller (140) stars the event after locally releasing the established N1 NAS signalling connection.

Further, the unavailability period collision controller (140) does not include the uplink data status IE or the allowed PDU session status IE in the REGISTRATION REQUEST message even when the UE (100) has one or more active always-on PDU sessions associated with a 3GPP access.

The unavailability period collision controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal.

However, the term “non-transitory” should not be interpreted that the memory (130) is non-movable. In certain examples, a non-transitory storage medium may store data that can, over time, change (e.g., in Random Access Memory (RAM) or cache).

Although the FIG. 7 shows various hardware components of the UE (100) but it is to be understood that other embodiments are not limited thereon. In other embodiments, the UE (100) may include less or a greater number of components. Further, the labels or names of the components are used only for illustrative purpose and does not limit the scope of the invention. One or more components can be combined together to perform same or substantially similar function in the UE (100).

FIG. 8 is a flow chart (S800) illustrating a method for handling the UE (100) during the unavailability period in the wireless network (1000), according to the embodiments as disclosed herein. The operations (S802-S810) are handled by the unavailability period collision controller (140).

At S802, the method includes detecting that the network apparatus supports for the unavailability period in the last registration procedure. At S804, the method includes determining that the event is triggered. The event makes the UE (100) to become un-available. At S806, the method includes creating the REGISTRATION REQUEST message by including the information to indicate unavailability period that starts im-mediately. At S808, the method includes setting the follow-on request indicator to “No follow-on request pending” and not include an uplink data status IE or an allowed PDU session status IE in the REGISTRATION REQUEST message. At S810, the method includes sending the REGISTRATION REQUEST message to the network apparatus (700).

The various actions, acts, blocks, steps, or the like in the flow chart (S800) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-14. (canceled)

15. A method of a user equipment (UE) in a wireless network, the method comprising:
identifying that a network apparatus supports an unavailability period;
in case that the network apparatus is identified to support the unavailability period, generating a registration request message including unavailability period duration information; and
transmitting the registration request message to the network apparatus,
wherein an uplink data status information element (IE) or an allowed protocol data unit (PDU) session status IE is not included in the registration request message even when the UE has one or more active always-on PDU sessions associated with a third generation partnership project (3GPP) access.

16. The method of claim 15, further comprising:
setting a follow-on request indicator within the registration request message to “No follow-on request pending”.

17. The method of claim 15, further comprising:
starting a timer to allow the network apparatus to release N1 non access stratum (NAS) signaling connection; and
locally releasing an established N1 NAS signaling connection in case that the timer is expired.

18. The method of claim 15, further comprising:
determining whether the UE is able to store a mobility management (MM) context and a session management (SM) context of the wireless network,
wherein, in case that the UE is able to store the MM context and the SM context, the unavailability period duration information is included in the registration request message, and the uplink data status IE or the allowed PDU session status IE is not included in the registration request message even when the UE has one or more active always-on PDU sessions associated with the 3GPP access.

19. The method of claim 17, further comprising:
establishing an N1 NAS signaling connection after locally releasing the established N1 NAS signaling connection.

20. The method of claim 15, wherein the unavailability period is caused by at least one of: a silent reset at a modem of the UE, a security patch update at the UE, an operating system (OS) upgrade at the UE, a modem software update at the UE, a device reboot upon modem setting changes via an open mobile alliance device management (OMA-DM), or a discontinuous coverage period of the UE applicable for satellite access.

21. The method of claim 15, wherein the unavailability period starts immediately, in case that the unavailability period duration information is included in a non access stratum (NAS) message and a start time is not included in the registration request message.

22. A user equipment (UE) in a wireless network, comprising:
a memory;
a processor; and
a controller, communicatively coupled to the memory and the processor, configured to:
identify that a network apparatus supports an unavailability period,
in case that the network apparatus is identified to support the unavailability period, generate a registration request message including unavailability period duration information, and
transmit the registration request message to the network apparatus,
wherein an uplink data status information element (IE) or an allowed protocol data unit (PDU) session status IE is not included in the registration request message even when the UE has one or more active always-on PDU sessions associated with a third generation partnership project (3GPP) access.

23. The UE of claim 22, the controller is further configured to:
set a follow-on request indicator within the registration request message to “No follow-on request pending”.

24. The UE of claim 22, wherein the controller is further configured to:
start a timer to allow the network apparatus to release N1 non access stratum (NAS) signaling connection; and
locally release an established N1 NAS signaling connection in case that the timer is expired.

25. The UE of claim 22, wherein the controller is further configured to:
determine whether the UE is able to store a mobility management (MM) context and a session management (SM) context of the wireless network,
wherein, in case that the UE is able to store the MM context and the SM context, the unavailability period duration information is included in the registration request message, and the uplink data status IE or the allowed PDU session status IE is not included in the registration request message even when the UE has one or more active always-on PDU sessions associated with the 3GPP access.

26. The UE of claim 24, wherein the controller is further configured to:
establish an N1 NAS signaling connection after locally releasing the established N1 NAS signaling connection.

27. The UE of claim 22, wherein the unavailability period is caused by at least one of: a silent reset at a modem of the UE, a security patch update at the UE, an operating system (OS) upgrade at the UE, a modem software update at the UE, a device reboot upon modem setting changes via an open mobile alliance device management (OMA-DM), or a discontinuous coverage period of the UE applicable for satellite access.

28. The UE of claim 22, wherein the unavailability period starts immediately, in case that the unavailability period duration information is included in a non access stratum (NAS) message and a start time is not included in the registration request message.
